(19) United States
(12) Patent Application Publication
(10) Pub. No.: US 2017/0227624 A1
(43) Pub. Date: Aug. 10, 2017

(54) ARRANGEMENT FOR, AND METHOD OF, ACCURATELY LOCATING TARGETS IN A VENUE WITH OVERHEAD, SENSING NETWORK UNITS

(71) Applicant: SYMBOL TECHNOLOGIES, LLC, LINCOLNSHIRE, IL (US)

(72) Inventor: THOMAS E. WULFF, BROOKHAVEN, NY (US)

(21) Appl. No.: 15/040,041

(22) Filed: Feb. 10, 2016

(51) Int. Cl. G01S 5/00; G01S 5/16; G01S 5/18; G01S 5/02

(52) U.S. Cl. CPC G01S 5/0018; G01S 5/0294; G01S 5/16; G01S 5/18

(57) ABSTRACT

Multiple sensing network units are deployed in a venue. Each unit includes an overhead housing, and supports a plurality of electrically-powered sensor modules for sensing targets in the venue, and for generating target data indicative of the targets. Each unit preferably also includes a network communications module. Each module is interchangeably mounted in the housing. A power and data distribution system transmits network control data and electrical power to the sensor modules, and transmits the target data away from the sensor modules.

### BACKGROUND OF THE INVENTION

The present disclosure relates generally to an arrangement for, and a method of, accurately locating targets in a venue, such as a retail, factory, or warehouse environment, by operating overhead, sensing network units, each preferably having a plurality of mutually cooperating sensor modules, such as a radio frequency (RF) identification (RFID) tag reader module for reading RFID tag targets, and/or a video module for capturing a video stream of images of the targets, and/or an ultrasonic locationing module for locating the targets by transmitting and receiving ultrasonic energy between the ultrasonic module and the targets, and/or a wireless communications module for transmitting and receiving wireless communications between the targets and the sensing network units.

Radio frequency (RF) identification (RFID) systems are known for product locationing, product tracking, product identification, and inventory control in retail, factory, or warehouse environments. For example, as shown in FIG. 1, in order to take an inventory of products 12 associated with RFID tags in a warehouse environment or venue 10, it is known to position a plurality of RFID tag readers 14 at overhead locations in the venue 10, and then, to operate each such reader 14, under the control of a network host computer or server 16, to interrogate and read payloads, i.e., target data, of any such tags that are in a coverage range of each reader 14. As shown, a multitude of tags may be in the coverage range of each reader 14. A specific location of any particular RFID-tagged product 12 in the venue 10 is typically determined by having the server 16 process the target data of a plurality of the readers 14 by using triangulation/trilateration techniques (schematically shown by dashed lines) known in the art.

Instead of the RFID system, it is also known to position a plurality of device locationing devices of a device locationing system in the venue 10 to determine the location of mobile devices, such as handheld RFID tag readers, handheld bar code symbol readers, phones, radios, watches, tablets, radios, or computers, that are carried and/or worn by people movable within the venue 10. The mobile devices can also be product movers, such as trucks or forklifts, movable within the venue 10. For example, as also shown in FIG. 1, a plurality of ultrasonic transmitters, e.g., speakers 18, can be mounted virtually anywhere, preferably at overhead locations in the venue 10, and operated, under the control of the network server 16, to determine the location, i.e., target data, of any such mobile device that contains an ultrasonic receiver, e.g., a microphone. Each ultrasonic speaker 18 transmits ultrasonic energy in a short burst which is received by the microphone on the mobile device, thereby establishing the presence and specific location of each mobile device within the venue 10, again using triangulation/trilateration techniques known in the art.

Instead of the RFID and device locationing systems, it is still further known, as further shown in FIG. 1, to install a video system in which a plurality of video cameras 20 are positioned and distributed throughout the venue 10. The cameras 20 may be located for the most part almost anywhere in the venue 10. Each video camera 20 is operated, under the control of the network server 16, to capture a video stream of images of targets, i.e., target data, in its imaging field of view. The targets can be the aforementioned RFID-tagged products 12, or RFID-tagged trucks, such as forklifts 22, for moving the products 12, and/or the aforementioned mobile devices, and/or can even be people 24, such as employees or customers, under surveillance by the cameras 20. The employees 24 may be carrying the aforementioned RFID-tagged products 12, and/or the aforementioned mobile devices, and/or may be operating the aforementioned RFID-tagged forklifts 22.

It is yet also known to install a wireless communications system by deploying, as yet further shown in FIG. 1, a plurality of Wi-Fi access points 8 for transmitting and receiving wireless communications throughout the venue 10. Wi-Fi is an available wireless standard for wirelessly exchanging data between electronic devices, thereby establishing a local area network in the venue 10.

Although FIG. 1 depicts only three tag readers 14 of the RFID system, only three speakers 18 of the ultrasonic locationing system, only three cameras 20 of the video system, and only three access points 8 of the wireless communications system, a typical venue 10 may have just one or more of these systems, and up to ten, or twenty, or even more of such pieces of equipment for each such system depending on the size and layout of the venue 10. Although generally satisfactory for their intended purposes, the spaced-apart installation of all these many individual pieces of equipment is complex, costly, time-consuming, and labor-intensive. The spaced-apart installation of all these individual pieces of equipment requires the routing of many individual data cables (not shown in FIG. 1 for clarity), sometimes along circuitous cable runs, between each such piece of equipment and the network server 16, which is tasked with the control and operation of each such piece of equipment, typically through a network switch 26, in order to conduct control data to, and to conduct the target data away from, each such piece of equipment. In addition, each such piece of equipment requires electrical power, and individual power cables (also not shown in FIG. 1 for clarity) have to be routed, again sometimes along indirect cable runs, to each such piece of equipment.

The spaced-apart installation of each such piece of equipment, together with the routing and connections of the multiple data and power cables, represents a significant installation burden and cost. Furthermore, the spaced-apart installation of all these individual pieces of equipment, if not carefully planned, can often be regarded as unsightly, particularly in a retail setting. The installation of the cameras 20 is particularly problematic, because many people 24, especially customers, do not appreciate being under surveillance. Most importantly, the spaced-apart installation of each such piece of equipment also introduces non-negligible signal processing delays since data generated at the different locations of the different pieces of equipment have to be individually identified as to their individual points or nodes of origin, and have to be correlated with each other from an analytics perspective. Managing data from a multitude of such nodes is a complex task that increases overall system complexity, processing, and associated latency. Such delays can negatively impact the accuracy of locating and tracking the targets, especially when the targets are moving.

Accordingly, it would be desirable to simplify, and reduce the cost and time of, installing RFID tag readers and/or device locationing devices and/or video cameras and/or access points in a venue, as well as to install such pieces of equipment in an aesthetic manner in the venue, and, furthermore, to minimize signal processing delays to thereby more accurately locate and track the targets than heretofore.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic view of a known RFID system, a known device locationing system, a known video system, and a known wireless communications system, one or more of such systems being deployed in a warehouse environment in accordance with the prior art.

FIG. 2 is a perspective view, as seen from above, of a retail venue in which an overhead, sensor network unit, shown in schematic view, is deployed in accordance with the present disclosure.

FIG. 3 is a perspective view, as seen from below, of a preferred embodiment of the unit of FIG. 2.

FIG. 4 is an elevational view of the embodiment of FIG. 3.

FIG. 5 is a bottom plan view of the embodiment of FIG. 3, and showing a bottom access door in a closed position.

FIG. 6 is a perspective view of the embodiment of FIG. 3, and showing the bottom access door in an open position.

FIG. 7 is a broken-away, enlarged, sectional view of the embodiment of FIG. 3, and showing the interior of the unit.

FIG. 8 is a block diagram showing the electrical connections among various built-in modules mounted in the interior of the embodiment of FIG. 3.

FIG. 9 is a perspective view of the embodiment of FIG. 3, as seen from below, with the access door open, and depicting a representative module prior to installation.

FIG. 10 is a view analogous to FIG. 8, depicting the representative module after installation.

FIG. 11 is a perspective view depicting a representative module prior to being latched in the unit.

FIG. 12 is a view analogous to FIG. 11, depicting the representative module after being latched.

FIG. 13 is another perspective view depicting the representative module after being latched.

FIG. 14 is an enlarged, perspective view of a representative module prior to being locked.

FIG. 15 is a view analogous to FIG. 10, depicting the representative module after being locked.

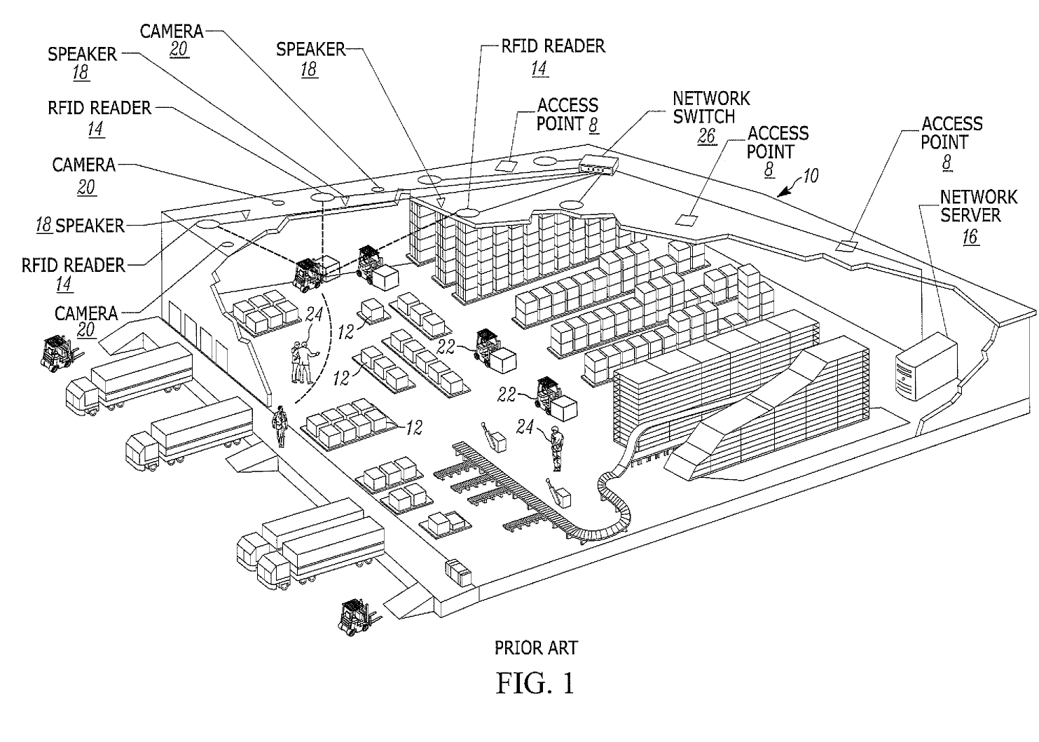

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The arrangement and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of this disclosure relates to a sensing network unit for accurately locating targets in a venue, such as a retail, factory, or warehouse environment. The unit includes a common housing mounted at a single overhead location in the venue, and a plurality of electrically-powered sensor modules supported by the common housing, for sensing the targets in the venue, and for generating target data indicative of location of the targets. For example, the plurality of the sensor modules could include a radio frequency (RF) identification (RFID) tag reader module for reading targets configured as RFID tags in the venue over a coverage range, and/or a video module for capturing a video stream of images of targets in the venue over an imaging field of view, and/or an ultrasonic locationing module for locating targets in the venue by transmitting and receiving ultrasonic energy between the ultrasonic locationing module and the targets, and/or a wireless local area network (WLAN) communications module for wireless communication between the targets and the ultrasonic locationing module. The unit also includes a power and data distribution system for transmitting network control data and electrical power to the sensor modules, and for transmitting the target data away from the sensor modules.

At least two of the modules mutually cooperate with other to accurately locate the targets. For example, the RFID module may determine the general location or neighborhood of the tag with a certain level of accuracy, and the video module may determine the location of the tag with a higher or finer level of accuracy by locating the person who is holding or moving the tag. As another example, the ultrasonic locationing module may determine the general location or neighborhood of the mobile device with a certain level of accuracy, and the communications module may determine the location of the mobile device with a higher or finer level of accuracy by advising the ultrasonic locationing module when the ultrasonic energy was actually received by the mobile device. As still another example, all the modules may cooperate with each other to locate the target with a high degree of precision.

In a preferred embodiment, the power and data distribution system includes a networking control switch mounted in the common housing, an exterior power and data cable connected to the unit, and a plurality of interior Power-over-Ethernet (PoE) cables each connected between a respective module and the networking control switch. Each PoE cable supplies the electrical power and transmits the control data to the respective module over a single cable.

Another aspect of this disclosure is directed to an arrangement for accurately locating targets in a venue. The arrangement includes a network or host computer or server, and a plurality of the above-described sensing network units operatively connected to the network server and deployed in the venue.

A further aspect of this disclosure is directed to a method of accurately locating targets in a venue. The method is performed by supporting a plurality of electrically-powered sensor modules on a common housing, and by mounting the common housing with the supported sensor modules at a single overhead location in the venue. The method is further performed by generating first target data indicative of location of the targets with a first of the sensor modules, by generating second target data indicative of the location of the targets with a second of the sensor modules in cooperation with the first sensor module, by supplying electrical power to the sensor modules, by transmitting network control data and electrical power to the sensor modules, and by transmitting the target data away from the sensor modules.

In accordance with this disclosure, the installation of multiple RFID tag readers and/or device locationing devices and/or video cameras and/or access points at a venue has been simplified, and can be performed in less time and at less cost than heretofore. Individual pieces of such equipment are no longer separately installed and spaced apart from one another, but instead, they are configured as modules that are incorporated or built into each network sensing unit. Thus, one of the modules could be configured as an RFID tag reader module, and another of the modules could be configured as a video module, and still another of the modules could be configured as an ultrasonic locationing module, and yet another of the modules could be configured as a communications module. Any two or more of such modules could be selected and incorporated into each single sensing network unit, thereby reducing the number of pieces of equipment that needs to be installed at a particular venue. Individual data and power cables are no longer separately routed to and from each such piece of equipment. Now, a single PoE cable is exteriorly connected to each sensing network unit to carry power and data to all the modules, and PoE cables are interiorly connected to each module to carry both the power and the data. The installation of the cameras within each unit is especially advantageous not only because the installation is more aesthetic than heretofore, but also because the cameras are substantially hidden within the housing of each unit and, therefore, are less noticeable to any persons who object to being under surveillance. Signal processing delays are minimized since all the data generated at each unit have the same point or node of origin, and no longer have to be correlated with each other from an analytics perspective. Managing data from a single node is a simpler and less complex processing task with lower latency than heretofore. Minimizing such delays greatly increase the accuracy of locating and tracking the targets, especially when the targets are moving.

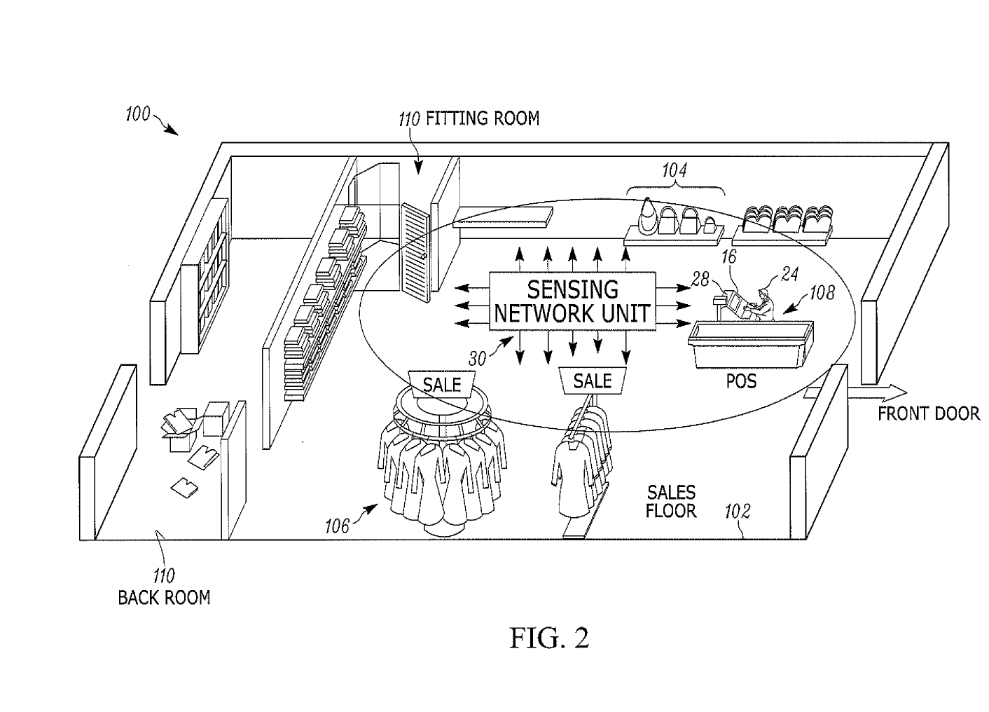

Turning now to the drawings, FIG. 2 schematically depicts a sensing network unit 30 for accurately locating targets, in accordance with this invention, in a retail venue 100 having a retail sales floor 102 on which a point-of-sale (POS) station 108 is provided with a network host computer or server 16 and an interface 28 that is operated by a retail employee 24. The retail venue 100 also typically has a fitting room 110 and a backroom 110 away from the sales floor 102. It will be understood that, in many applications, the server 16 is preferably located in the backroom 110. To simplify FIG. 2, only one sensing network unit 30 has been illustrated as being preferably located overhead on the ceiling above the sales floor 102. It will be further understood that more than one sensing network unit 30 could be, and preferably are, deployed in the venue 100, and not necessarily deployed on the ceiling. Advantageously, sensing network units 30 can be installed apart every twenty to eighty feet or so in a square grid. As described below, many different types of targets can be sensed by the sensing network unit 30. Such targets include, for example, people, such as the employee 24, who is under video surveillance, as well as the various retail products being offered for sale on the floor 102, e.g., clothes 106, handbags 104, etc., that are arranged on shelves, hangers, racks, etc. As described below, each such product is preferably tagged with a radio frequency (RF) identification (RFID) tag, preferably a passive RFID tag for cost reasons. It will be further understood that, in some applications, for example, in a warehouse venue, each RFID tag may be associated with a pallet or a container for multiple products.

The server 16 comprises one or more computers and is in wired, wireless, direct, or networked communication with the interface 28 and with each sensing network unit 30. The interface 28 provides a human/machine interface, e.g., a graphical user interface (GUI), that presents information in pictorial and/or textual form (e.g., representations of bearings of the RFID-tagged products 104, 106) to the employee 24, and to initiate and/or alter the execution of various processes that may be performed by the server 16. The server 16 and the interface 28 may be separate hardware devices and include, for example, a computer, a monitor, a keyboard, a mouse, a printer, and various other hardware peripherals, or may be integrated into a single hardware device, such as a mobile smartphone, or a portable tablet, or a laptop computer. Furthermore, the user interface 28 can be in a smartphone, or tablet, etc., while the server 16 may be a local computer, or can be remotely hosted in a cloud server. The server 16 may include a wireless RF transceiver that communicates with each sensing network unit 30. For example, Wi-Fi and Bluetooth® are open wireless standards for exchanging data between electronic devices.

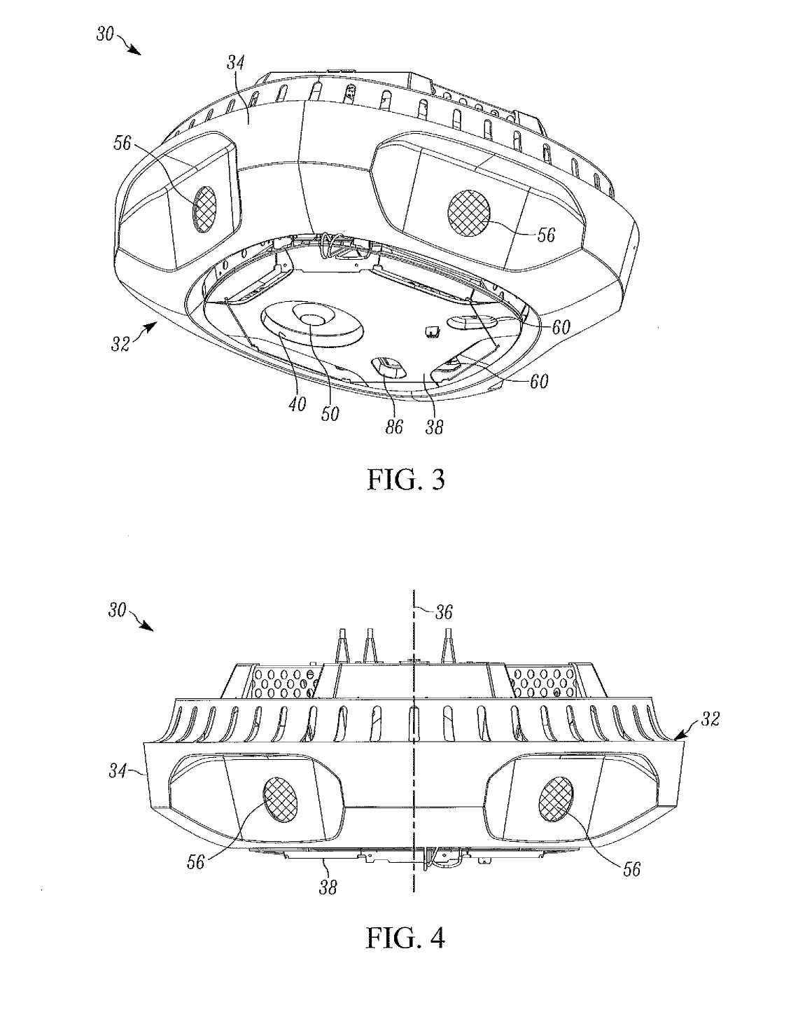

A preferred embodiment of each sensing network unit 30 is depicted in FIGS. 3-7. Each unit 30 has a generally circular, hollow, common housing 32 mounted at a single overhead location in the venue 100. Preferably, an upright, vertical post 80 extends downwardly from a ceiling, and a lower end of the post 80 is connected to an apertured plate or cage 82 that is attached to a bracket 84 that, in turn, is connected to the housing 32. The housing 32 has an outer wall 34 bounding an upright, vertical axis 36 and a bottom wall, which is configured as a hinged access door 38. The door 38 has a generally circular opening 40. The housing 32 supports a plurality of electrically-powered sensor modules operative for sensing targets in the venue 100, and for generating target data indicative of the targets 100.

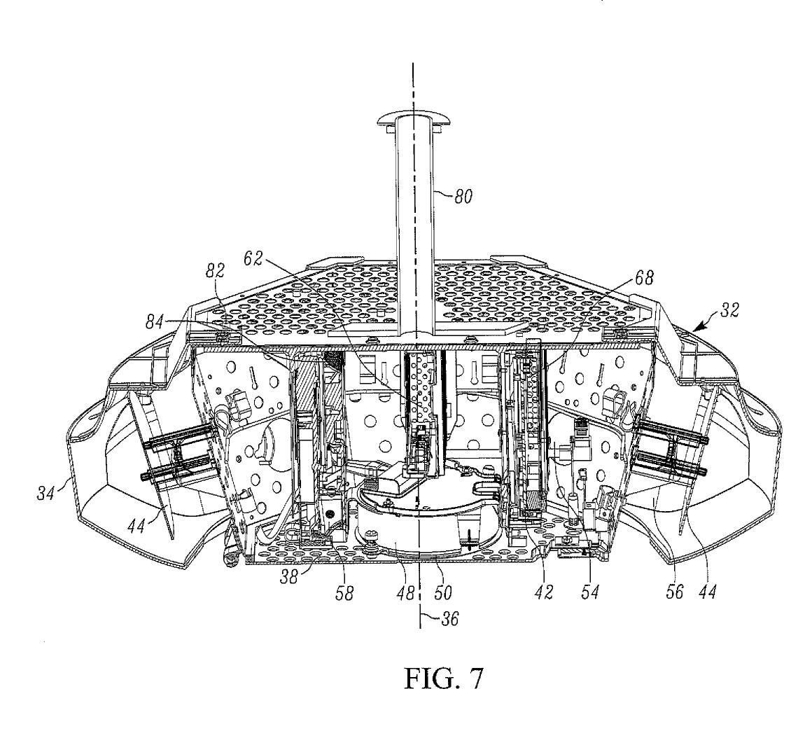

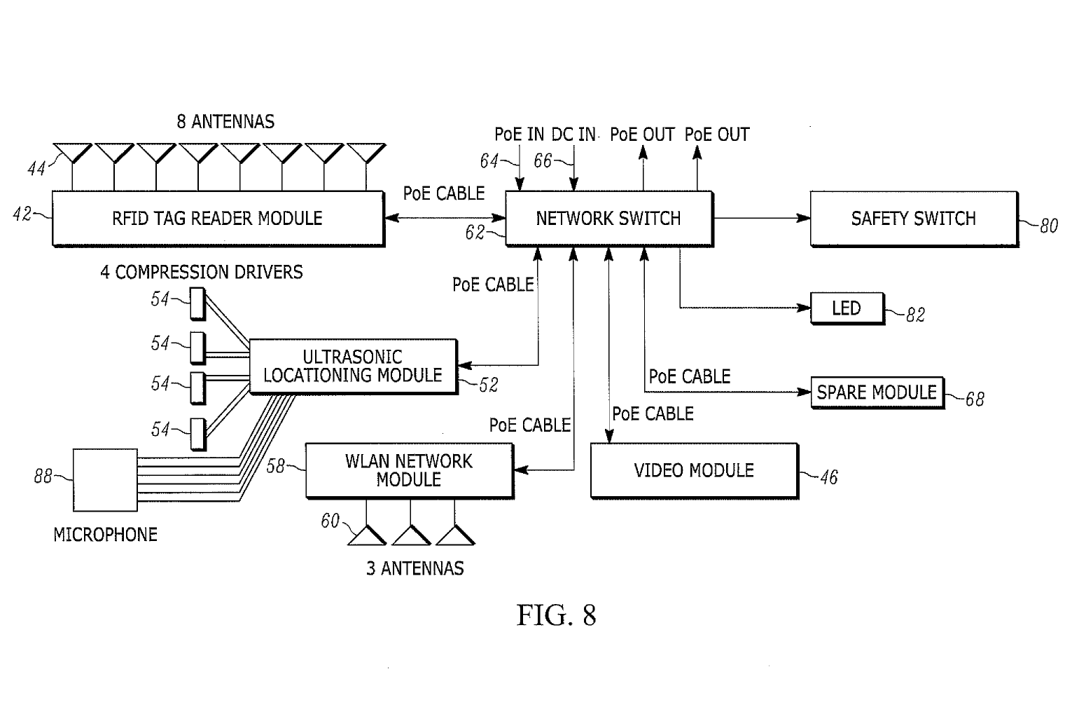

As best shown in FIG. 8, one of the sensor modules may be a radio frequency (RF) identification (RFID) tag reader module 42 that is interchangeably mounted within the housing 32, for reading targets configured as RFID tags in the venue 100 over its coverage range. The RFID module 42 includes control and processing electronics that are operatively connected to a plurality of RFID antennas 44. The RFID module 42 includes an RF transceiver operated, under the control of the server 16, to steer an interrogating RF beam across, and interrogate and process the payloads of, any RFID tags that are in its coverage range. It will be understood that there may be thousands of RFID tags in the venue 100. The RFID antennas 44 receive a return RF beam from the interrogated tag(s), and the RFID module 42 decodes an RF signal from the return RF beam, under the control of the server 16, into decoded data. The decoded data, also known as a payload or target data, can denote a serial number, a price, a date, a destination, a location, other attribute(s), or any combination of attributes, and so on, for the tagged product. As best shown in FIG. 7, the RFID antennas 44 are mounted inside the housing 32 and are arranged, preferably equiangularly spaced apart, about the upright axis 36. The outer wall 34 covers the RFID antennas 44 and acts as a radome to protect the RFID antennas 44. The outer wall 34, as well as the housing 32, is constituted of a material, such as plastic, through which RF signals can readily pass.

As also shown in FIG. 8, another of the sensor modules may be a video module 46 interchangeably mounted within the housing 32, and operatively connected to a camera 48, also mounted within the housing 32. The video module 46 includes camera control and processing electronics for capturing a video stream of images of targets, e.g., target data, in the venue 100 over an imaging field of view at a frame rate and a resolution. Preferably, the frame rate and/or the resolution are adjustable. The targets can, for example, be the aforementioned RFID-tagged products 104, 106, and can even be people, such as the employee 24 or customers, under surveillance by the camera 48. The camera 48 has a lens 50 that faces, and is optically aligned with, the opening 40 in the access door 38. The camera 48 is advantageously a high-bandwidth, moving picture expert group (MPEG) compression camera.

As further shown in FIG. 8, still another of the sensor modules may be an ultrasonic locationing module 52 interchangeably mounted within the housing 32, for locating targets in the venue 100 by transmitting and receiving ultrasonic energy between the ultrasonic locationing module 52 and the targets. The targets are typically mobile devices, such as a handheld RFID tag reader, a handheld bar code symbol reader, a smartphone, a tablet, a watch, a computer, a radio, or the like, each device being equipped with a transducer, such as a microphone. The locationing module 52 includes control and processing electronics operatively connected to a plurality of compression drivers 54 and, in turn, to a plurality of ultrasonic transmitters, such as voice coil or piezoelectric speakers 56. The ultrasonic speakers 56 are preferably mounted on the outer wall 34 and are arranged, preferably equiangularly spaced apart, about the upright axis 36. A feedback microphone 88 may also be mounted on the outer wall 34.

As still further shown in FIG. 8, still another of the modules may be a wireless local area network (WLAN) communications module 58 interchangeably mounted within the housing 32, for wireless communication over a network at the venue 100. The communications module 58 includes control and processing electronics that are operatively connected to a plurality of WLAN antennas 60 that are mounted, and spaced apart, on the housing 32. The communications module 58 serves as a Wi-Fi access point for transmitting and receiving wireless communications throughout the venue 10. Wi-Fi is an available wireless standard for wirelessly exchanging data between electronic devices, thereby establishing a local area network in the venue.

At least two of the modules mutually cooperate with other to accurately locate the targets. For example, the RFID module 42 may determine the general location or neighborhood of the tag with a certain level of accuracy, and the video module 46 may determine the location of the tag with a higher or finer level of accuracy by locating the person who is holding or moving the tag. As another example, the ultrasonic locationing module 52 may determine the general location or neighborhood of the mobile device with a certain level of accuracy, and the communications module 58 may determine the location of the mobile device with a higher or finer level of accuracy by advising the ultrasonic locationing module 52, as described below, when the ultrasonic energy was actually received by the mobile device. As still another example, all the modules 42, 46, 52, 58 may cooperate with each other to locate the target with a high degree of precision.

Each ultrasonic speaker 56 periodically transmits ultrasonic ranging signals, preferably in short bursts or ultrasonic pulses, which are received by a microphone on the mobile device. The microphone determines when the ultrasonic ranging signals are received. The communications module 58 advises the ultrasonic locationing module 52 when the ultrasonic ranging signals were received. The locationing module 52, under the control of the server 16, directs all the speakers 56 to emit the ultrasonic ranging signals such that the microphone on the mobile device will not receive overlapping ranging signals from the different speakers. The flight time difference between the transmit time that each ranging signal is transmitted and the receive time that each ranging signal is received, together with the known speed of each ranging signal, as well as the known and fixed locations and positions of the speakers 56 on each sensing unit 30, are all used to determine the position of the microphone mounted on the mobile device, and, in turn, the position of the mobile device, also known as target data, using a suitable locationing technique, such as triangulation, trilateration, multilateration, etc.

A power and data distribution system is employed for transmitting network control data and electrical power to the sensor modules 42, 46, 52, and for transmitting the target data away from the sensor modules 42, 46, 52. The power and data distribution system includes a networking control switch 62 mounted within the housing 32, an exterior power and data cable, preferably a Power-over-Ethernet (PoE) cable, connected between each unit 30 and the server 16, and a plurality of interior PoE cables each connected between a respective module 42, 46, 52, 58 and the networking control switch 62. Each PoE cable connected to the modules 42, 46, 52 transmits the electrical power and transmits the control data thereto from the networking control switch 62, and transmits the target data away from the respective module 42, 46, 52 to the networking control switch 62. The PoE cable connected to the communications module 58 transmits the electrical power and transmits the control data thereto from the networking control switch 62, and transmits communications data away from the communications module 58 back to the server 16.

The exterior PoE cable is connected between a power source (not illustrated) and an input port 64 on the networking control switch 62. An optional DC power line 66 can be connected to the networking control switch 62. A spare module 68 can be accommodated within the housing 32. The spare module can be another sensor module, or, advantageously, can be another communications module operating under a different protocol, such as the Bluetooth® protocol or the ultra wideband protocol.

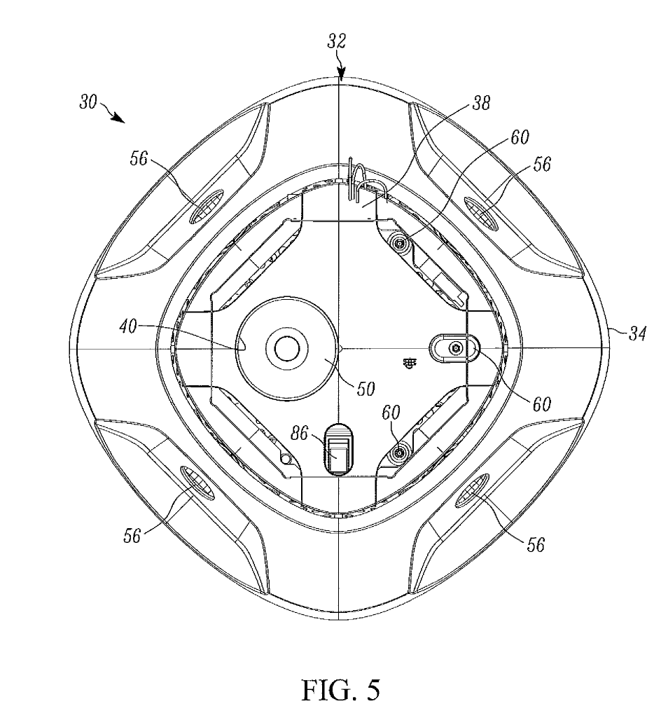

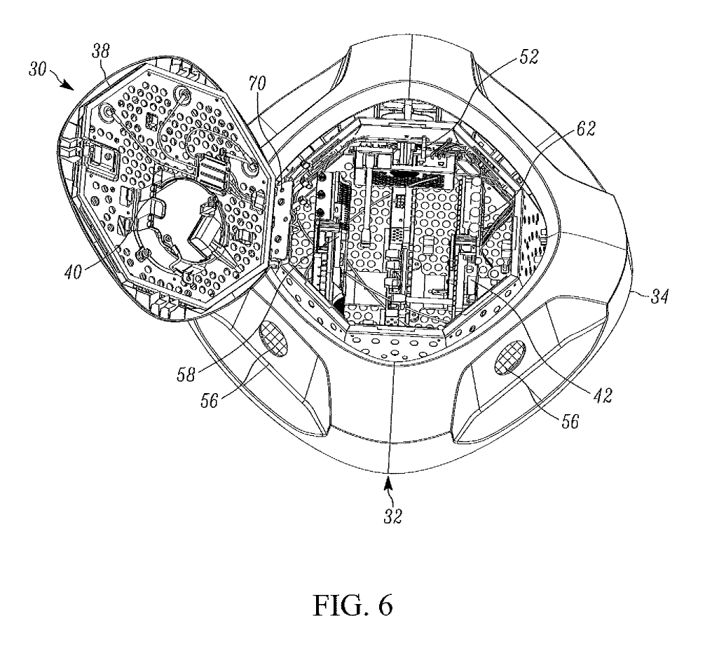

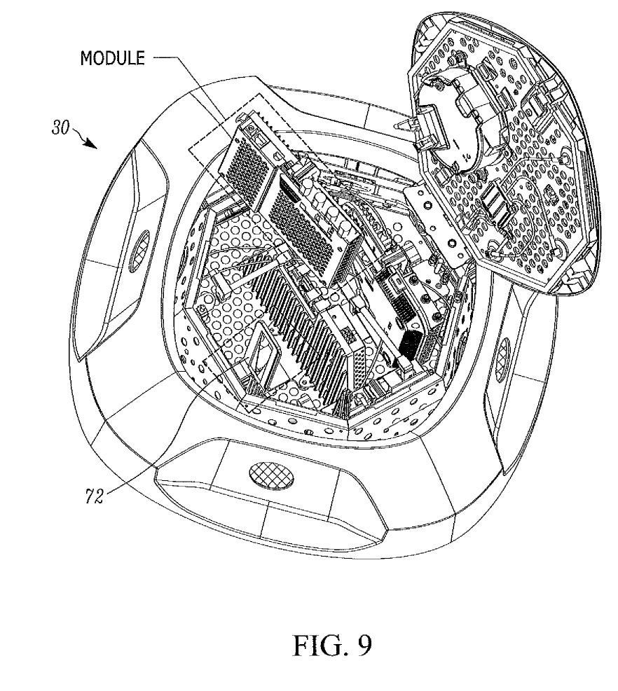

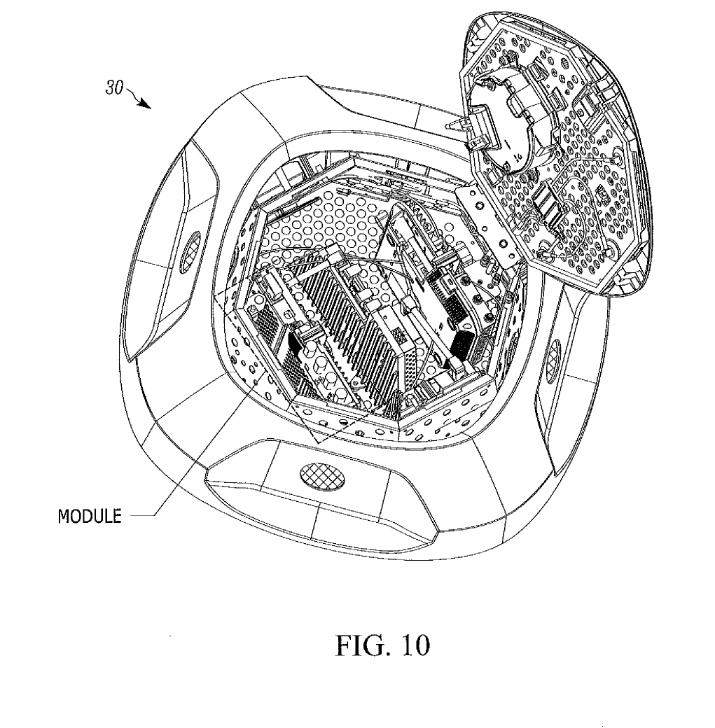

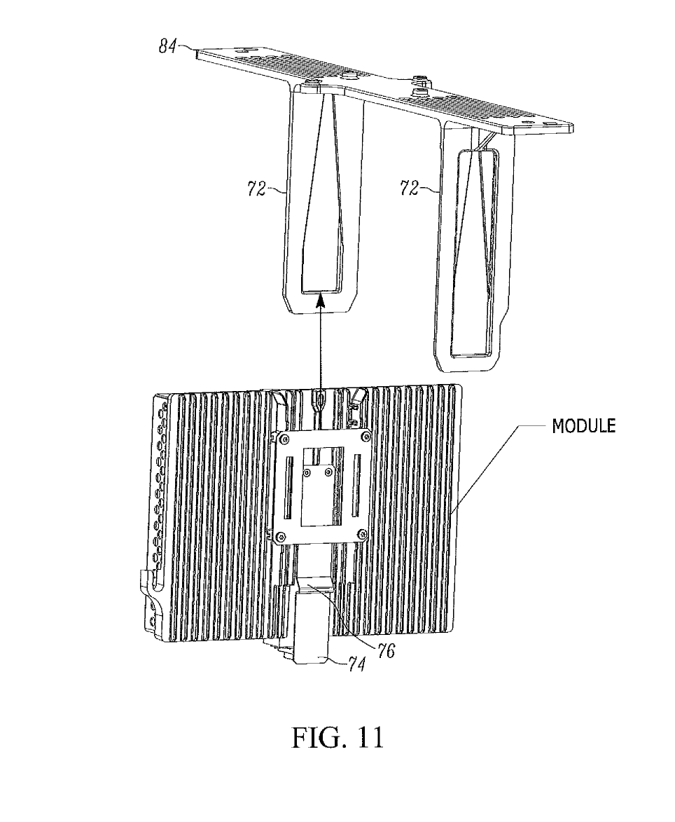

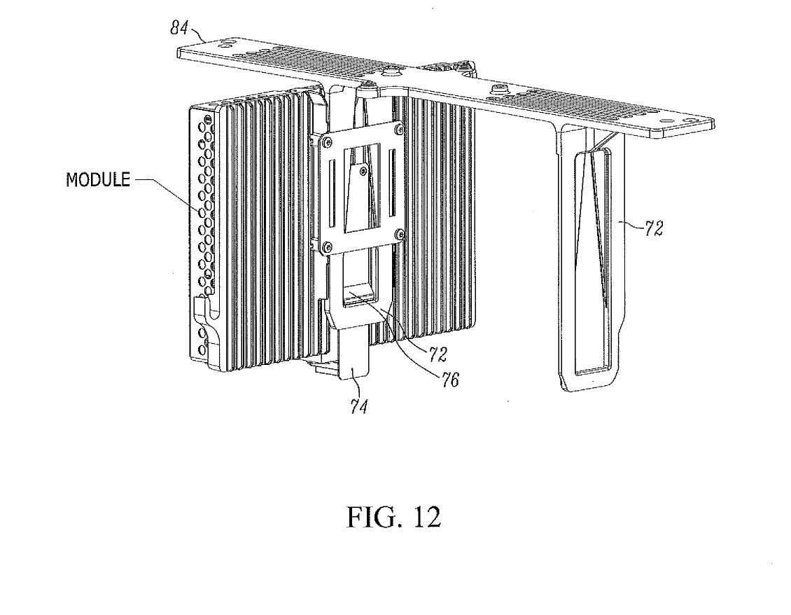

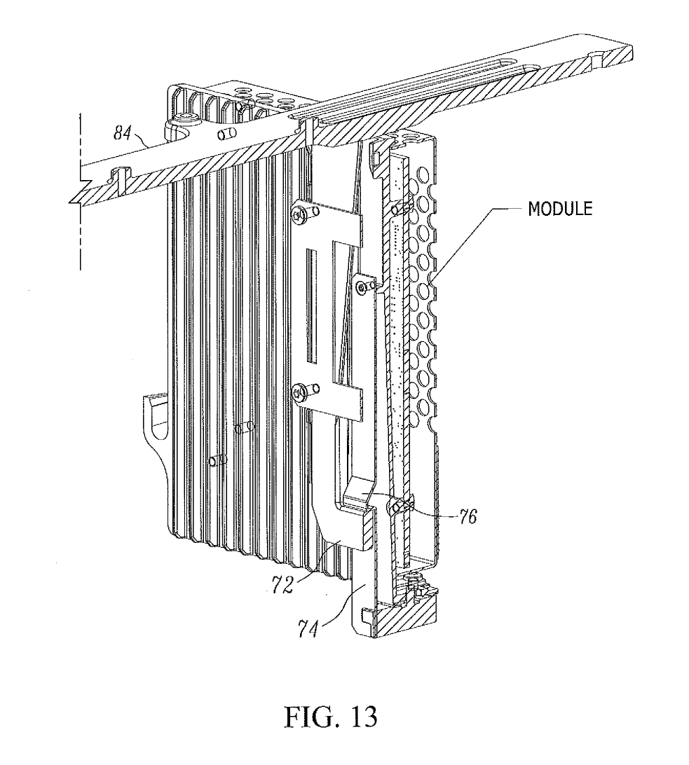

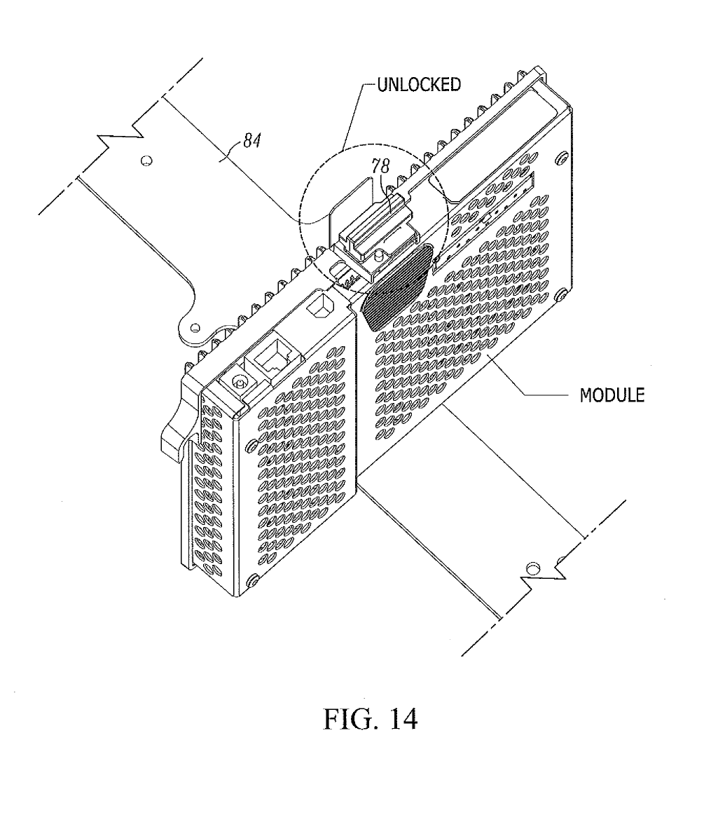

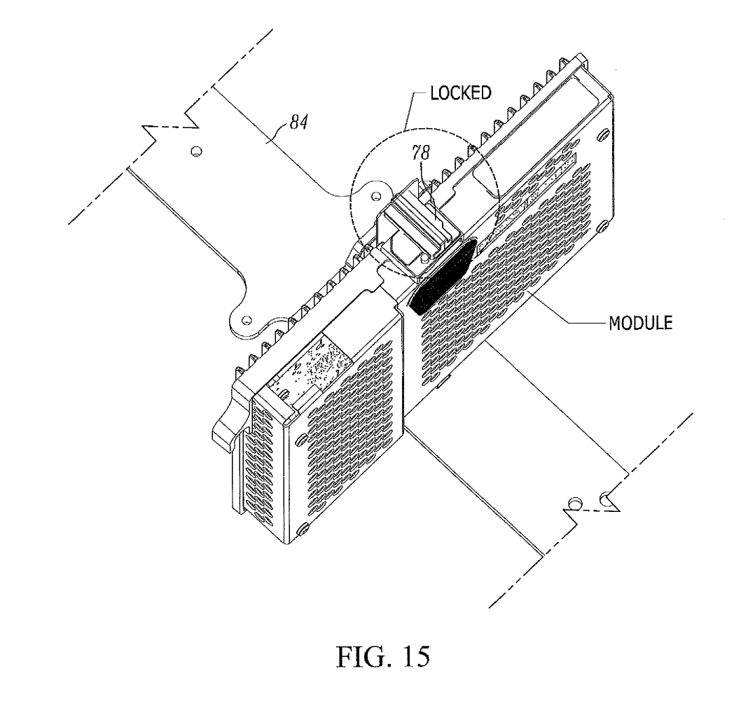

The aforementioned access door 38 is hinged at hinge 70 to the housing 32 for movement between an open position (FIG. 6) and a closed position (FIG. 5). A slide switch 86 is moved to unlock the access door 38. In the open position shown in FIG. 6, the modules 42, 46, 52, 58 are all accessible to be installed in the housing 32, or to be removed from the housing 32 and replaced with another module for maintenance and repair. FIG. 9 depicts a representative mounting slot 72 mounted within the housing 32, and a representative module prior to being mounted in the slot 72. FIG. 10 depicts the representative module after being mounted in the slot 72. Each module is inserted into, and mounted in, its own mounting slot 72. As best shown in FIGS. 11-13, each of the modules has a resilient arm 74 having a raised latch 76 for self-latchingly engaging a respective mounting slot 72 with a spring action after insertion of each module. To disengage the raised latch 76, pressure is exerted on the arm 74 until the raised latch 76 clears the slot 72. As best shown in FIGS. 14-15, each of the modules has a lock 78, which, when turned, locks the latch 76 in the slot 72, thereby insuring that any module will not unlatch and fall from the housing 32 when the door 38 is opened.

A safety switch 80 (see FIG. 8) senses the position of the door 38, and discontinues or cuts the electrical power to the modules when the door 38 is in the open position. An indicator 82, e.g., a light emitting diode (LED), visually signals that the electrical power has been cut off

In the foregoing specification, specific embodiments have been described. However, one of ordinary skill in the art appreciates that various modifications and changes can be made without departing from the scope of the invention as set forth in the claims below. Although the invention has been described for use with modules 42, 46, 52, 58, different modules, or different combinations of modules, can be mounted in each unit 30. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A sensing network unit for accurately locating targets in a venue, comprising:
a common housing mounted at a single overhead position in the venue;
a plurality of electrically-powered sensor modules supported by the common housing at the single overhead position, for sensing the targets in the venue, a first of the sensor modules being operative for generating first target data indicative of location of the targets, and a second of the sensor modules being operative, in cooperation with the first sensor module, for generating second target data indicative of the location of the targets; and
a power and data distribution system for transmitting network control data and electrical power to, and for transmitting both the first and second target data away from, the sensor modules in the common housing at the single overhead position.

2. The sensing network unit of claim 1, wherein the common housing has an interior; and wherein the sensor modules are selected from a group of modules comprising: a radio frequency (RF) identification (RFID) tag reader module interchangeably mounted in the interior of the common housing, for reading the targets configured as RFID tags in the venue over a coverage range; a video module interchangeably mounted in the interior of the common housing, for capturing a video stream of images of the targets in the venue over an imaging field of view; an ultrasonic locationing module interchangeably mounted in the interior of the common housing, for locating the targets in the venue by transmitting and receiving ultrasonic energy between the ultrasonic locationing module and the targets; and a wireless local area network (WLAN) communications module interchangeably mounted in the interior of the common housing, for wireless communication between the targets and the ultrasonic locationing module.

3. The sensing network unit of claim 2, wherein the common housing has an outer wall bounding an upright axis, and further comprising a plurality of RFID antenna elements operatively connected to the RFID tag reader module and arranged about the upright axis within the interior of the common housing.

4. The sensing network unit of claim 2, wherein the common housing has a bottom wall formed with an opening, and further comprising a camera operatively connected to the video module and mounted within the interior of the common housing, and wherein the camera has a lens that faces, and is optically aligned with, the opening.

5. The sensing network unit of claim 2, wherein the common housing has an outer wall bounding an upright axis, and further comprising a plurality of ultrasonic speakers mounted on the outer wall, arranged about the upright axis, and operatively connected to the ultrasonic locationing module.

6. The overhead, multi-sensor unit of claim 1, wherein the power and data distribution system includes an exterior common cable connected to the common housing, the cable being operative for transmitting the network control data and the electrical power to, and for transmitting both the first and second target data away from, the common housing.

7. The sensing network unit of claim 6, wherein the power and data distribution system includes a networking control switch mounted in the interior of the common housing, and a plurality of interior Power-over-Ethernet (PoE) cables each connected between a respective module and the networking control switch, and wherein each PoE cable supplies the electrical power and transmits the control data to the respective module.

8. The sensing network unit of claim 6, wherein the common housing has a plurality of mounting slots in the interior of the common housing, and wherein each of the modules has a latch for latchingly engaging a respective mounting slot.

9. The sensing network unit of claim 6, wherein the common housing has a bottom access door movable between a closed position and an open position, and further comprising a safety switch for sensing the position of the door, and for discontinuing the electrical power to the modules when the door is in the open position.

10. An arrangement for accurately locating targets in a venue, comprising:
a network server; and
a plurality of sensing network units operatively connected to the network server, each unit including
a common housing mounted at a single overhead position in the venue,
a plurality of electrically-powered sensor modules supported by the common housing at the single overhead position, for sensing the targets in the venue, a first of the sensor modules being operative for generating first target data indicative of location of the targets, and a second of the sensor modules being operative, in cooperation with the first sensor module, for generating second target data indicative of the location of the targets, and
a power and data distribution system for transmitting network control data and electrical power to the sensor modules in the common housing at the single overhead position, and for transmitting both the first and second target data away from the sensor modules to the network server.

11. The arrangement of claim 10, wherein the common housing of each unit has an interior; and wherein the sensor modules of each unit are selected from a group of modules comprising: a radio frequency (RF) identification (RFID) tag reader module interchangeably mounted in the interior of the common housing, for reading the targets configured as RFID tags in the venue over a coverage range; a video module interchangeably mounted in the interior of the common housing, for capturing a video stream of images of the targets in the venue over an imaging field of view; an ultrasonic locationing module interchangeably mounted in the interior of the common housing, for locating the targets in the venue by transmitting and receiving ultrasonic energy between the ultrasonic module and the targets; and a wireless local area network (WLAN) communications module interchangeably mounted in the interior of the common housing, for wireless communication between the targets and the ultrasonic locationing module.

12. The arrangement of claim 11, wherein the power and data distribution system includes a networking control switch mounted in the interior of the common housing of each unit; an exterior common cable connected to the common housing of each unit, the cable being operative for transmitting the network control data and the electrical power to, and for transmitting both the first and second target data away from, the common housing; and a plurality of interior Power-over-Ethernet (PoE) cables each connected between a respective module and the networking control switch in each unit, and wherein each PoE cable supplies the electrical power and transmits the control data to the respective module in each unit.

13. A method of accurately locating targets in a venue, comprising:
supporting a plurality of electrically-powered sensor modules on a common housing;
mounting the common housing with the supported sensor modules at a single overhead position in the venue;
generating first target data indicative of location of the targets with a first of the sensor modules;
generating second target data indicative of the location of the targets with a second of the sensor modules in cooperation with the first sensor module;
transmitting electrical power and control data to the sensor modules in the common housing at the single overhead position; and
transmitting both the first and second target data away from the sensor modules in the common housing at the single overhead position.

14. The method of claim 13, and selecting the plurality of the sensor modules from a group of modules comprising: a radio frequency (RF) identification (RFID) tag reader module for reading targets configured as RFID tags in the venue over a coverage range, a video module for capturing a video stream of images of the targets in the venue over an imaging field of view, an ultrasonic locationing module for locating the targets in the venue by transmitting and receiving ultrasonic energy between the ultrasonic locationing module and the targets, and a wireless local area network (WLAN) communications module for wireless communication between the targets and the ultrasonic locationing module.

15. The method of claim 14, and operatively connecting a plurality of RFID antenna elements to the RFID tag reader module, and arranging the RFID antenna elements about an upright axis of the common housing.

16. The method of claim 14, and operatively connecting a camera to the video module, and optically aligning a lens of the camera with a bottom opening in the common housing.

17. The method of claim 14, and operatively connecting a plurality of ultrasonic speakers to the ultrasonic locationing module, and arranging the speakers about an upright axis of the common housing.

18. The method of claim 14, and mounting a networking control switch in the common housing, connecting all the modules through the networking control switch to a network server with an exterior common cable connected to the common housing, and connecting interior Power-over-Ethernet (PoE) cables between each module and the networking control switch to transmit the electrical power and the control data to a respective module.

19. The method of claim 18, and configuring the common housing with a plurality of mounting slots, and interchangeably mounting each of the modules with a latching engagement in a respective mounting slot.

20. The method of claim 18, and configuring the common housing with a bottom access door movable between a closed position and an open position, and sensing the position of the door, and discontinuing the electrical power to the modules when the door is in the open position.
